(19) United States
(12) Patent Application Publication
(10) Pub. No.: US 2026/0203966 A1
(43) Pub. Date: Jul. 16, 2026

(54) IMAGE PROCESSING APPARATUS AND METHOD, IMAGE PROCESSING SYSTEM, AND STORAGE MEDIUM

(71) Applicant: CANON KABUSHIKI KAISHA, Tokyo (JP)

(72) Inventors: YUSUKE YOSHIDA, Kanagawa (JP); SHUMA YOKOYAMA, Kanagawa (JP); TAKAYUKI KOMATSU, Kanagawa (JP); HIROSHI KANEKO, Kanagawa (JP)

(21) Appl. No.: 19/430,861

(22) Filed: Dec. 23, 2025

(30) Foreign Application Priority Data
Jan. 10, 2025 (JP) 2025-004335
Jun. 30, 2025 (JP) 2025-110914

(51) Int. Cl. G06T 11/10; G06F 40/40; G06T 5/94; G06T 7/11; G06T 7/90

(52) U.S. Cl. CPC G06T 11/10; G06F 40/40; G06T 5/94; G06T 7/11; G06T 7/90; G06T 2207/10024; G06T 2207/20021

(57) ABSTRACT

An image processing apparatus comprises: an acquisition unit that acquires an image; a first generation unit that generates a luminance image indicating luminance of the acquired image; and a second generation unit that generates text indicating characteristics of the acquired image.

### BACKGROUND

### Field of the Technology

The present disclosure relates to an image processing apparatus and method, an image processing system, and a storage medium, and more particularly to a technique for reducing the amount of data of a captured image without reducing the quality of the image.

### Description of the Related Art

Conventionally, image generation technologies such as DALL-E2 developed by OpenAI have been known that use sentences called prompts as input to generate images using a Visual Language Model (VLM) and a diffusion model.

On the other hand, International Publication No. 2021/161453 discloses a technique that uses a prediction model that predicts pixel color information from a specific classification and corresponding color information, and colorizes a monochrome image based on the monochrome image and the results of the prediction model.

In recent years, along with the evolution of smartphones and digital cameras, the resolution of image sensors has been increased. This increase in resolution has also led to an increase in the amount of data of captured color images, raising concerns about the strain on communication traffic and the capacity of storage media where images are stored, and creating a need for a reduction in the amount of data.

However, in a case where an attempt is made to reduce the amount of data of a color image using the image generation technique that uses the above-mentioned prompt as input, the following problem arises: in a case where an image is restored using the image data whose amount is reduced and the prompt, as the prompt is mainly composed of sentences and words, and therefore the resulting image lacks detailed information such as details and color expression compared to the captured image.

On the other hand, the conventional technique disclosed in International Publication No. 2021/161453 is a technique for colorizing monochrome images, and there is no mention of reducing the amount of data of color images.

### SUMMARY

The present disclosure has been made in consideration of the above situation, and provides highly reproducible color image data while reducing the amount of data required.

According to the present disclosure, provided is an image processing apparatus comprising one or more processors and/or circuitry which function as: an acquisition unit that acquires an image; a first generation unit that generates a luminance image indicating luminance of the acquired image; and a second generation unit that generates text indicating characteristics of the acquired image.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an example of a configuration of an image processing system comprising an image capturing apparatus according to an embodiment of the present disclosure.

FIG. 2 is a block diagram illustrating an example of a hardware configuration of the image capturing apparatus according to a first embodiment.

FIG. 3 shows a conceptual diagram for explaining a mechanism for generating a luminance image and a color information prompt according to the first embodiment.

FIG. 4 is a conceptual diagram for explaining a mechanism for restoring a color image according to the first embodiment.

FIG. 5 is a flowchart of processing according to the first embodiment.

FIG. 6 is a block diagram illustrating an example of a hardware configuration of an image capturing apparatus according to a second embodiment.

FIG. 7 is a block diagram illustrating an example of a functional configuration of a supplementary color information generation unit according to the second embodiment.

FIG. 8 is a flowchart of processing according to the second embodiment.

FIG. 9 shows a conceptual diagrams for explaining a mechanism for generating a luminance image and a color information prompt according to a third embodiment.

FIG. 10 is a flowchart of processing according to the third embodiment.

FIG. 11 is a block diagram illustrating an example of a functional configuration of a luminance image generation unit according to a fourth embodiment.

FIGS. 12A to 12C are conceptual diagrams illustrating an example of judgment processing by an edge detection determination unit according to the fourth embodiment.

FIG. 13 is a flowchart of processing according to the fourth embodiment.

FIG. 14 is a flowchart of edge detection determination process according to the fourth embodiment.

FIG. 15 is a conceptual diagram for explaining a mechanism for generating an object image and object information prompt according to a fifth embodiment.

FIG. 16 is a flowchart of processing according to the fifth embodiment.

FIG. 17 is a diagram illustrating details of an object image according to the fifth embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following embodiments, the present disclosure will be described as being implemented as an image processing system including an image capturing apparatus. However, the present disclosure can be implemented by using, as the image capturing apparatus, any electronic apparatus having an image capturing function. Such electronic apparatuses include video cameras, computer apparatuses (personal computers, tablet computers, media players, PDAs, etc.), mobile phones, smartphones, game consoles, robots, drones, and dashboard cameras. These are merely examples, and the present disclosure can also be implemented with other electronic apparatuses. Furthermore, the image capturing apparatus may not be configured as a single apparatus, but may be configured from an electronic apparatus having an image capturing function and an image processing apparatus that processes images obtained from the electronic apparatus.

### FIRST EMBODIMENT

### Configuration

First, an image processing system according to a first embodiment of the present disclosure will be described.

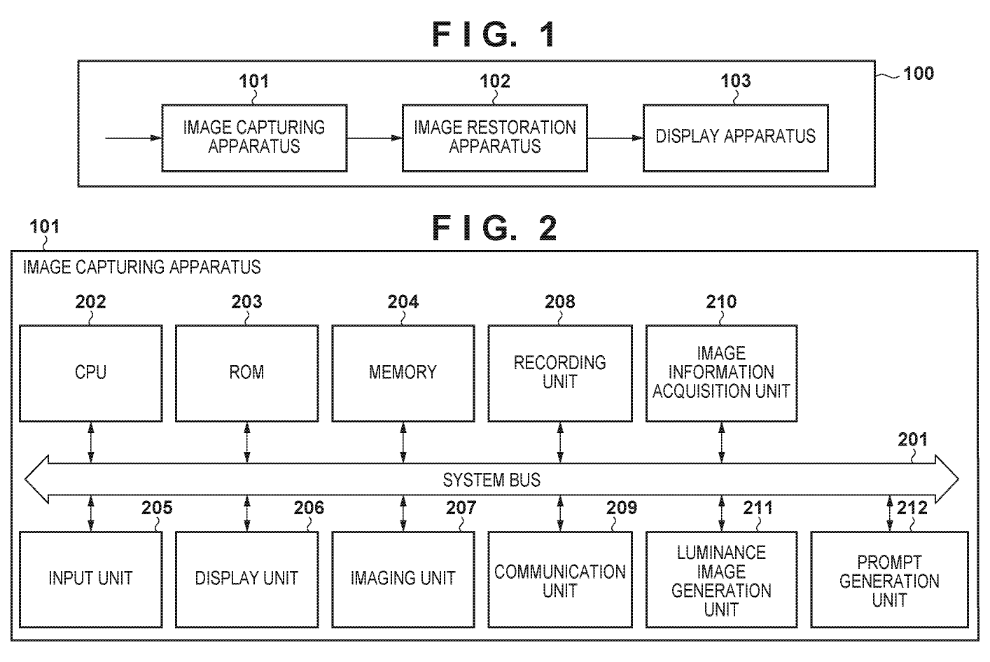

FIG. 1 illustrates an example configuration of an image processing system 100 according to the first embodiment of the present disclosure. As shown in FIG. 1, the image processing system 100 includes an image capturing apparatus 101, an image restoration apparatus 102, and a display apparatus 103. The image capturing apparatus 101, the image restoration apparatus 102, and the display apparatus 103 may each be configured independently, or at least partially integrated. The system may also include a storage apparatus for saving restored images.

The image capturing apparatus 101 captures image data corresponding to an optical image of a subject using a lens, an image sensor, etc. The image capturing apparatus 101 also applies predetermined image processing to the image data to generate image data (luminance image) using luminance value information of the captured image data and text information (prompt information) using feature information of the captured image data. Because the luminance image is composed of luminance value information, it is a grayscale image.

The image restoration apparatus 102 communicates with the image capturing apparatus 101 via a communication network to acquire the luminance image and the prompt information. Alternatively, the image restoration apparatus 102 may acquire the luminance image and the prompt information by connecting to a storage medium on which the image capturing apparatus 101 stores those data. The image restoration apparatus 102 restores the image using the luminance image and the prompt information acquired from the image capturing apparatus 101. For example, a convolutional neural network (CNN) may be used to restore a luminance image, which is a grayscale image, into a color image. In this case, the image restoration apparatus 102 can determine the type of color image to generate by referring to the text information of color information prompt included in the prompt information.

The display apparatus 103 acquires the restored color image from the image restoration apparatus 102 and displays it.

Next, an example of the hardware configuration of the image capturing apparatus 101 according to the present disclosure will be described with reference to FIG. 2.

The image capturing apparatus 101 includes a central processing unit (CPU) 202, a read only memory (ROM) 203, a memory 204, an input unit 205, a display unit 206, an imaging unit 207, a recording unit 208, a communication unit 209, an image information acquisition unit 210, a luminance image generation unit 211, and a prompt generation unit 212. These components of the image capturing apparatus 101 are connected to each other via a system bus 201 so as to be able to send and receive data to and from each other.

The CPU 202 is one or more processors capable of executing programs. The CPU 202 implements each functional block by, for example, loading a program stored in the ROM 203 into the memory 204 and executing the program. Note that the various programs required for the CPU 202 to operate may be stored not only in the ROM 203 but also in other storage areas such as a hard disk. The CPU 202 controls the operations of the display unit 206, the imaging unit 207, the recording unit 208, the communication unit 209, the image information acquisition unit 210, the luminance image generation unit 211, and the prompt generation unit 212 in accordance with the program, based on a control signal supplied from the input unit 205 in response to a user operation received by the input unit 205. This enables the image capturing apparatus 101 to perform operations in response to a user operation.

The ROM 203 is, for example, an electrically rewritable non-volatile memory, and stores various programs and the like required for the operation of the CPU 202.

The memory 204 is, for example, realized by a random access memory (RAM), and is a recording area that temporarily holds data. The CPU 202 uses the memory 204 as a working memory when executing the programs stored in the ROM 203, for example.

The input unit 205 accepts a user operation, generates a control signal in response to the user operation, and supplies the generated control signal to the CPU 202. The control signal is, for example, a signal instructing image capture or a signal indicating settings for image capture. The input unit 205 may also have, for example, physical operation buttons or a touch panel as an input device for accepting user operations. A touch panel is, for example, an input device configured to output coordinate information corresponding to the position of contact with an input unit configured in a planar manner. The input unit 205 may also accept user operations by voice recognition or line of sight detection.

The display unit 206 is realized by a display such as an LCD, and includes a mechanism for outputting a display signal for displaying an image on the screen. When a touch panel is used as the input unit 205, the input unit 205 and the display may be integrally configured. In this case, for example, the touch panel is configured so that the light transmittance of the touch panel does not interfere with the displayed image on the display, and is attached to the upper layer of the display surface of the display such that input coordinates on the touch panel correspond to coordinates on the display.

The imaging unit 207 is a mechanism that performs a series of image capture processes, and includes an imaging section, which consists of a lens, a shutter with an aperture function, and a sensor, such as a CCD or CMOS element, that converts an optical image into an electrical signal, and an image processing section, which performs various image processing, such as exposure control, based on the signals from the imaging section. The operation of the imaging unit 207 is controlled by the CPU 202, which allows it to capture an image of a subject in response to a user operation input via the input unit 205. In the present embodiment, the color image generated by the imaging unit 207 is described as being in the RGB format, but it may also be a RAW image, or the image processing section may perform image processing to convert a color image in any format into a YUV format, HSV format, or the like.

The communication unit 209 transmits and receives data to and from other terminals under the control of the CPU 202. The communication unit 209 may be realized, for example, by a network interface card (NIC) for a wired LAN, and may be connected to the NIC of the image restoration apparatus 102 to transmit the luminance image, the color information prompts, and the like stored in the recording unit 208 to the image restoration apparatus 102 (external device).

The image information acquisition unit 210 includes a luminance conversion unit that converts RGB data into luminance values using a predetermined algorithm such as an averaging method, a weighted average method, or a luminance method to generate image luminance information, and a color information conversion unit that generates image color information indicating color information of each pixel. Alternatively, the image information acquisition unit 210 may be configured to receive and output both the image luminance information and the image color information from the imaging unit 207.

The luminance image generation unit 211 generates a luminance image based on the image luminance information input from the image information acquisition unit 210 under the control of the CPU 202, and outputs the generated luminance image to the recording unit 208.

The prompt generation unit 212 is configured to include an image color information analysis section that analyzes the image color information input from the image information acquisition unit 210 under the control of the CPU 202, and a color information prompt generation section that generates a color information prompt indicating the color characteristics of the image based on the analysis results.

The recording unit 208 is, for example, a semiconductor memory card or a solid-state drive (SSD), and is a storage area for storing data such as captured images. The recording unit 208 is also used as a storage to store the luminance images generated by the luminance image generation unit 211 and the color information prompts generated by the prompt generation unit 212. In a case where both the luminance images and the color information prompts are stored in the recording unit 208, they may be associated with each other. For example, the color information prompt may be recorded as metadata (additional information) recorded in a data file that stores the image data of the luminance image. Alternatively, the color information prompt may be stored as a text file separate from the image data file of the luminance image.

### Generation of Luminance Image and Color Information Prompt

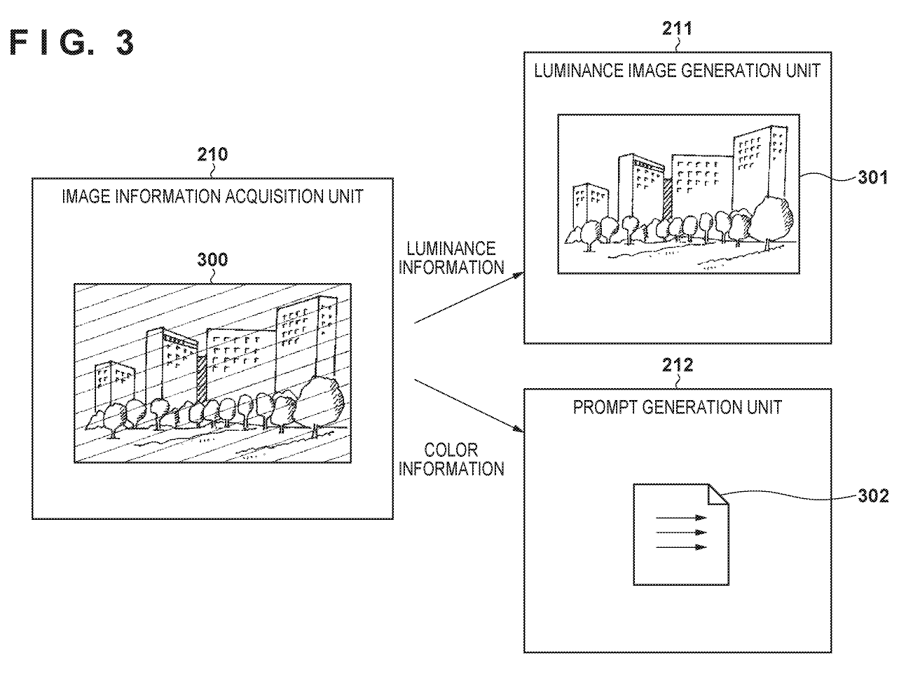

FIG. 3 is a conceptual diagram illustrating the mechanism for generating a luminance image and a color information prompt in this embodiment.

The image information acquisition unit 210 acquires a color image 300 from the imaging unit 207 and generates image luminance information and image color information from the color image. The image information acquisition unit 210 generates image luminance information by converting the RGB color image 300 acquired from the imaging unit 207, for example, into luminance values using a specified algorithm.

Then, the luminance image generation unit 211 generates a luminance image 301 (grayscale image) from the image luminance information.

Meanwhile, the prompt generation unit 212 analyzes the image color information to generate a color information prompt 302, which is text indicating color characteristics. The prompt generation unit 212 generates, as the color information prompt 302, information obtained by analyzing the color components contained in the image, for example, by color clustering. Alternatively, the prompt generation unit 212 may generate, as the color information prompt 302, information such as an RGB color code value of a specific pixel in the image and corresponding coordinate values indicating the position of the pixel. Note that the information included in the color information prompt 302 is not limited to this, and any color information obtained from the analysis results may be used.

### Color Image Restoration

Next, an explanation is given of how a color image is restored from a luminance image and a color information prompt in this embodiment.

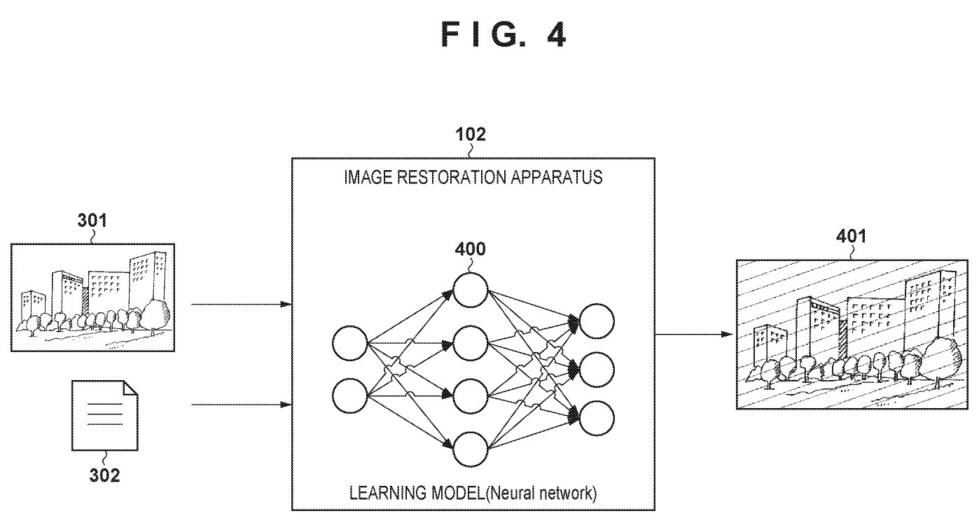

FIG. 4 is a conceptual diagram illustrating how the image restoration apparatus 102 restores a color image from a luminance image and color information prompt in this embodiment. The image restoration apparatus 102 acquires the luminance image 301 and color information prompt 302 shown in FIG. 3 and restores a color image 401. In this embodiment, the image restoration apparatus 102 restores a color image from a grayscale image through inference processing by a neural network using a learning model 400, as shown in FIG. 4. Note that the color image restoration method is not limited to this and can also be achieved using image generation AI or known techniques such as those described in the following reference: Richard Zhang and Jun-Yan Zhu, "Real-Time User-Guided Image Colorization with Learned Deep Priors," ACM Transactions on Graphics, May 8, 2017.

### Processing

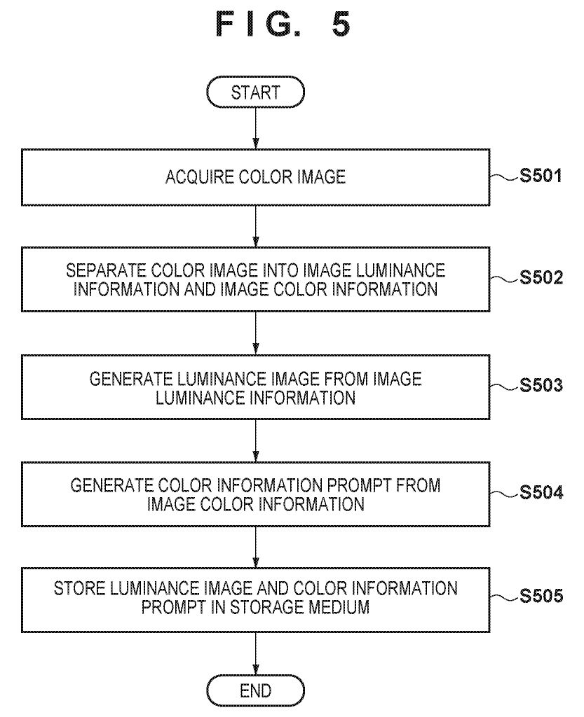

Next, with reference to the flowchart in FIG. 5, an example of a series of processes performed in this embodiment in a case where the image capturing apparatus 101 captures an image and saves a luminance image and a color information prompt to a recording medium will be described. Note that the operation of each step is achieved by the CPU 202 executing a program stored in the ROM 203 and controlling other hardware as necessary.

In step S501, the imaging unit 207 receives a user operation from the input unit 205, captures a still image, and acquires a color image. Alternatively, the imaging unit 207 may capture a moving image and use a frame image of the moving image as the color image. The imaging unit 207 outputs the acquired color image to the image information acquisition unit 210. The imaging unit 207 may also process the color image before outputting it, for example, to make it suitable for processing by the image information acquisition unit 210. Then, the process proceeds to step S502.

In step S502, the image information acquisition unit 210 separates the color image into image luminance information and image color information, outputs the image luminance information to the luminance image generation unit 211, and outputs the image color information to the prompt generation unit 212, and then the process proceeds to step S503.

In step S503, the luminance image generation unit 211 generates a luminance image from the image luminance information, outputs it to the recording unit 208, and the process proceeds to step S504.

In step S504, the prompt generation unit 212 generates a color information prompt from the image color information and outputs it to the recording unit 208. Note that the color information prompt may include not only a description of the color elements included in the image (positive prompt) but also a description of the color elements not included in the image (negative prompt). Then, the process proceeds to step S505.

In step S505, the recording unit 208 saves the luminance image and the color information prompt. At this time, the luminance image and the color information prompt may be saved in association with each other. For example, the color information prompt may be recorded as metadata recorded in a data file that stores the image data of the luminance image. Alternatively, the color information prompt may be saved as a text file separate from the image data file of the luminance image. Then, the processing ends.

As described above, according to the first embodiment, the amount of image data can be reduced by separating and storing the luminance image and the color information prompt, and the colors can be restored with high reproducibility. That is, the image data can be saved as a grayscale image using only the image luminance information, thereby reducing the amount of data. Further, by generating the color information prompt from the image color information of the image data, the grayscale image can be restored to a color image, making it possible to restore a color image with high color reproducibility. As a result, even in a case where an image is captured using a camera with a high-resolution sensor, for example, the amount of image data can be reduced, preventing congestion due to the amount of data.

### SECOND EMBODIMENT

Next, a second embodiment of the present disclosure will be explained.

In the second embodiment, an explanation is given of an example of a mechanism for further improving color reproducibility, when image restoration is performed, by adding additional color-related supplementary information to increase the accuracy of color information prompt.

In this embodiment, only the parts that are particularly different from those in the first embodiment will be described, and the description of parts that are substantially the same as those in the first embodiment will be omitted as appropriate. The configuration of the image processing system 100 in the second embodiment is the same as that described in the first embodiment with reference to FIG. 1. However, the configuration of the image capturing apparatus 101 is different from that in the first embodiment, and will be described below.

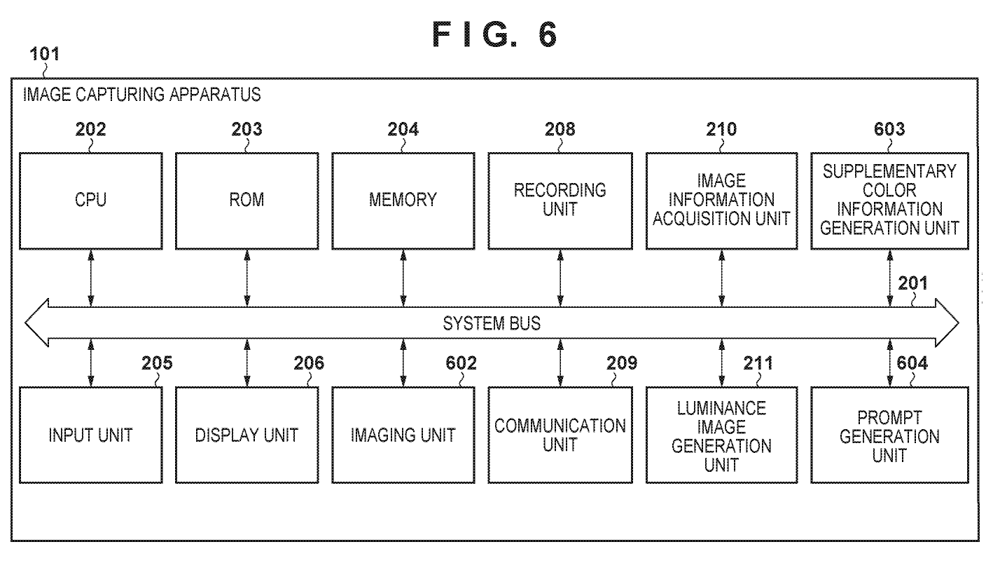

FIG. 6 is a block diagram illustrating the hardware configuration of the image capturing apparatus 101 according to the second embodiment. The hardware configuration of the image capturing apparatus 101 shown in FIG. 6 differs from that of the first embodiment in that a supplementary color information generation unit 603 is added to the configuration of the image capturing apparatus 101 shown in FIG. 2, and the operation of an imaging unit 602 and a prompt generation unit 604 differs from that in the first embodiment. Other components are the same as those shown in FIG. 2, and therefore the same reference numerals are used and description thereof will be omitted.

The imaging unit 602 outputs image capture information such as image capture settings and subject detection results to the supplementary color information generation unit 603. The supplementary color information generation unit 603 acquires the image capture information such as image capture settings and subject detection results from the imaging unit 602, analyzes color information from the image capture information to generate supplementary color information, and outputs the generated information to the prompt generation unit 604. The prompt generation unit 604 generates a color information prompt using the image color information from the image information acquisition unit 210 and the supplementary color information from the supplementary color information generation unit 603.

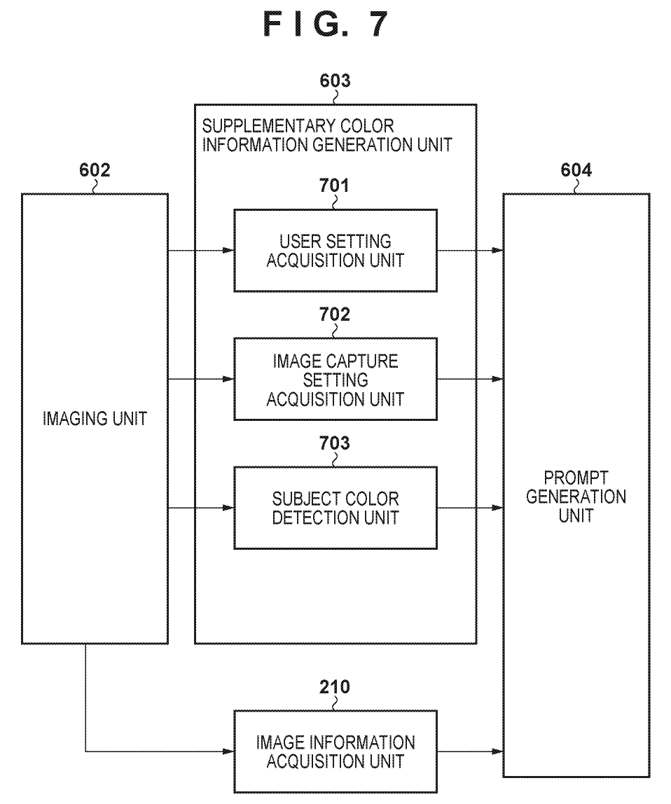

FIG. 7 is a block diagram illustrating an example of the function of the supplementary color information generation unit 603 included in the image capturing apparatus of the second embodiment.

Under the control of the CPU 202, the imaging unit 602 performs image capture and image processing using various information such as user setting information for the image settings desired by the user, image capture setting information indicating information about the settings at the time of image capture, and subject detection information using the autofocus (AF) function at the time of image capture.

A user setting acquisition unit 701 acquires user setting information of image settings set by the user according to their preferences from the imaging unit 602, and outputs it as supplementary color information to the prompt generation unit 604. The user setting information is, for example, information about the color tone of an image set by the user, such as a user preset that allows the user to set the image to their preferred color tone. Note that the user setting information is not limited to this, and may include a color temperature input as a numerical value or information obtained by learning the user's setting preferences.

An image capture setting acquisition unit 702 acquires image capture setting information, which is information related to settings for capturing an image, from the imaging unit 602 and outputs the information as supplementary color information to the prompt generation unit 604. The image capture setting information is, for example, white balance setting information, that is information related to settings at the time of capturing an image, such as color temperature information (Kelvin) at the time of capturing an image. Note that the image capture setting information is not limited to this and may also include color-related information such as location information of the location where the image was captured, time, season, manufacturer information, etc. For example, information about the time and season may be used to determine the color temperature of the image to be restored and the color of the leaves, etc., depending on the time of day and season, such as morning, evening, spring, or autumn. Furthermore, since the characteristics of color creation through image processing differ depending on the manufacturer, it is also possible to restore the color of a specified manufacturer, for example, using an AI model that has learned images linked to each manufacturer.

A subject color detection unit 703 acquires subject detection information and image data from the imaging unit 602. Note that subject detection may be performed using a conventional method such as that used in autofocus (AF) function. The subject color detection unit 703 detects information about the subject's color from the subject information and the image data, and outputs this information as supplementary color information to the prompt generation unit 604. For example, in a case where information indicating that a person is recognized, the subject color detection unit 703 detects the color of the person's shirt or pants. The subject to be detected is not limited to a person, and may include animals, buildings, the sky, etc.

The prompt generation unit 604 generates a color information prompt indicating color characteristics using the supplementary color information input from the image capture setting acquisition unit 702 and the image color information acquired from the image information acquisition unit 210.

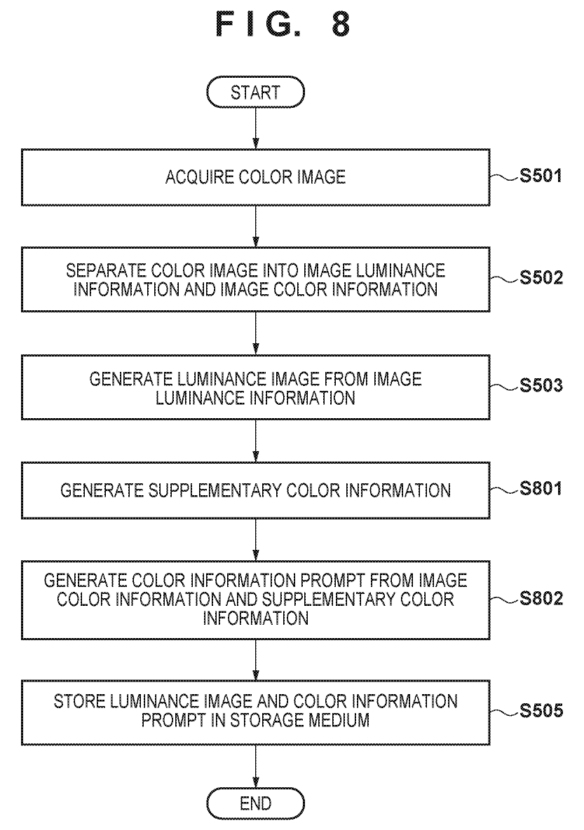

FIG. 8 is a flowchart of processing in the second embodiment. Here, an example of a series of processes will be described in which the image capturing apparatus 101 captures an image and stores a luminance image and a color information prompt in a recording medium. The operation of each step is realized by the CPU 202 executing a program recorded in the ROM 203 and controlling other hardware as necessary. In the processing shown in FIG. 8, steps S501 to S503 and S505 are the same as those described with reference to FIG. 5 in the first embodiment, and therefore will not be described again.

In step S801, the supplementary color information generation unit 603 acquires information such as image capture settings and subject detection results from the imaging unit 602, generates supplementary color information, and outputs it to the prompt generation unit 604. Then, the process proceeds to step S802.

In step S802, the prompt generation unit 604 generates a color information prompt using the image color information from the image information acquisition unit 210 and the supplementary color information from the supplementary color information generation unit 603, and outputs it to the recording unit 208, then the process proceeds to step S505.

As described above, according to the second embodiment, by acquiring supplementary color information from image capture information, user setting information, subject recognition information, etc., it is possible to generate a more suitable color information prompt, thereby further improving color reproducibility in image restoration.

### THIRD EMBODIMENT

Next, a third embodiment of the present disclosure will be explained.

In the third embodiment, an explanation is given of an example of a mechanism for further reducing an amount of data of a luminance image by converting the luminance image into a binary edge image.

In this embodiment, only the parts that are particularly different from those in the first embodiment will be described, and the description of the parts that are substantially the same as those in the first embodiment will be omitted as appropriate. Also, as the image processing system in the third embodiment, the image processing system 100 described in the first embodiment using FIGS. 1, 2, and 4 is used.

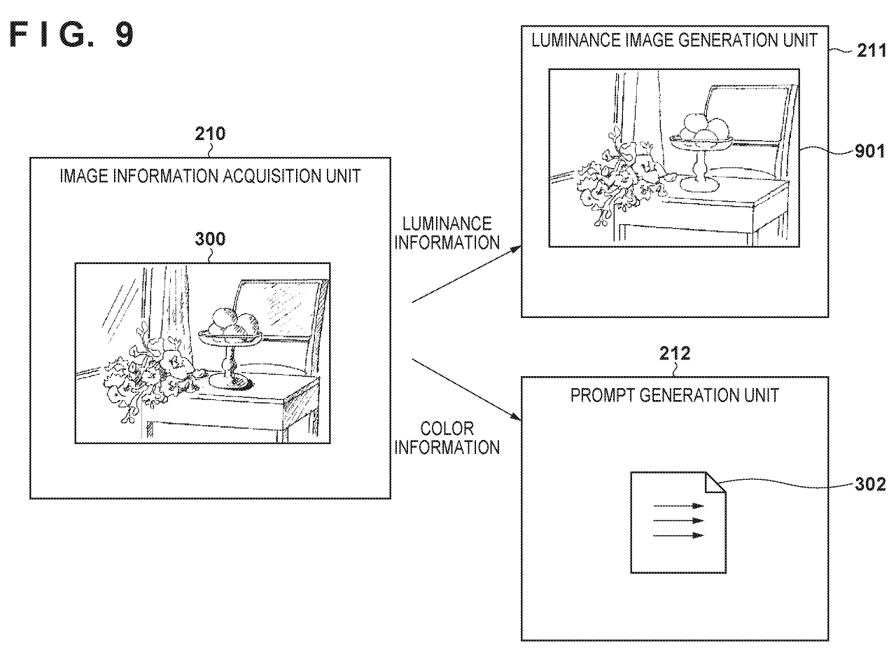

FIG. 9 is a conceptual diagram for explaining the mechanism for generating a luminance image and a color information prompt in this embodiment.

The luminance image generation unit 211 generates a binary edge image 901 from the image luminance information received from the image information acquisition unit 210. The edge image 901 is a luminance image in which the contours (edges) of an object are detected with high accuracy using, for example, the Canny edge detection method and the edges are enhanced.

Furthermore, the image restoration apparatus 102 can restore the color image 401 using the edge image 901 and the color information prompt 302 without losing the details of the color image 300 at the time of image capture.

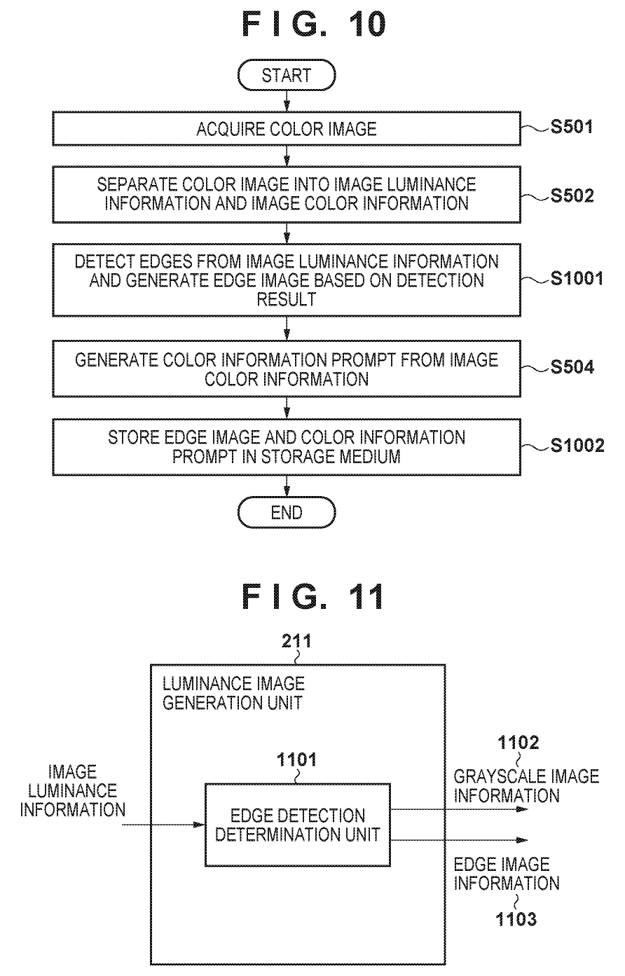

Next, an example of a series of processes performed in a case where the image capturing apparatus 101 captures an image and stores the edge image 901 and a color information prompt on a recording medium will be described with reference to the flowchart in FIG. 10. Note that the operation of each step is achieved by the CPU 202 executing a program recorded in the ROM 203 and controlling other hardware as necessary. In the process shown in FIG. 10, the processes of steps S501, S502, and S504 are the same as those described in the first embodiment with reference to FIG. 5, and therefore will not be described here.

In step S1001, the luminance image generation unit 211 detects edges in the luminance image and generates the edge image 901. Then, the process proceeds to step S504.

In step S1002, the recording unit 208 stores the edge image 901 and the color information prompt. Note that the recording unit 208 may store the edge image 901 and the color information prompt in association with each other, as in the first embodiment. Then, the processing ends.

As described above, according to the third embodiment, among image data, a binary edge image generated by using image luminance information is saved, which makes it possible to further reduce the amount of data. Furthermore, by restoring a color image from a color information prompt and the edge image, it is possible to restore details of the color image, such as composition and color, with high reproducibility. As a result, even in a case where an image is captured using a camera with a high-resolution sensor, for example, the amount of image data can be reduced, preventing congestion due to the amount of data.

However, the first and third embodiments have a trade-off relationship in terms of an amount of image data and reproducibility in detail. Specifically, compared to the first embodiment, which uses a grayscale image, the third embodiment uses a binary edge image, which reduces the amount of data per pixel. Therefore, the third embodiment is superior in terms of the amount of image data. On the other hand, the grayscale image expresses a higher degree of luminance gradation than the binary edge image, so the first embodiment is superior in terms of reproducibility in detail. Therefore, it is advisable to select an appropriate method depending on the capability of the system to which the present disclosure is applied.

### FOURTH EMBODIMENT

Next, a fourth embodiment of the present disclosure will be explained.

In the fourth embodiment, an explanation is given of an example of a mechanism for, in generating a luminance image, reducing an amount of data of the luminance image and improving color reproducibility by adaptively using a grayscale image and a binary edge image.

In this embodiment, only the parts that are particularly different from those of the first and third embodiments will be described, and the description of the parts that are substantially the same as those in the first and third embodiments will be omitted as appropriate. As in the first and third embodiments, the image processing system in the fourth embodiment uses the image processing system 100 described with reference to FIGS. 1, 2, and 4.

FIG. 11 is a block diagram illustrating a functional configuration of the luminance image generation unit 211 in the fourth embodiment.

The luminance image generation unit 211 in the fourth embodiment analyzes the image luminance information received from the image information acquisition unit 210 using an edge detection determination unit 1101 to determine whether or not object edges can be detected. Furthermore, based on the analysis results, it outputs either grayscale image information 1102 or edge image information 1103.

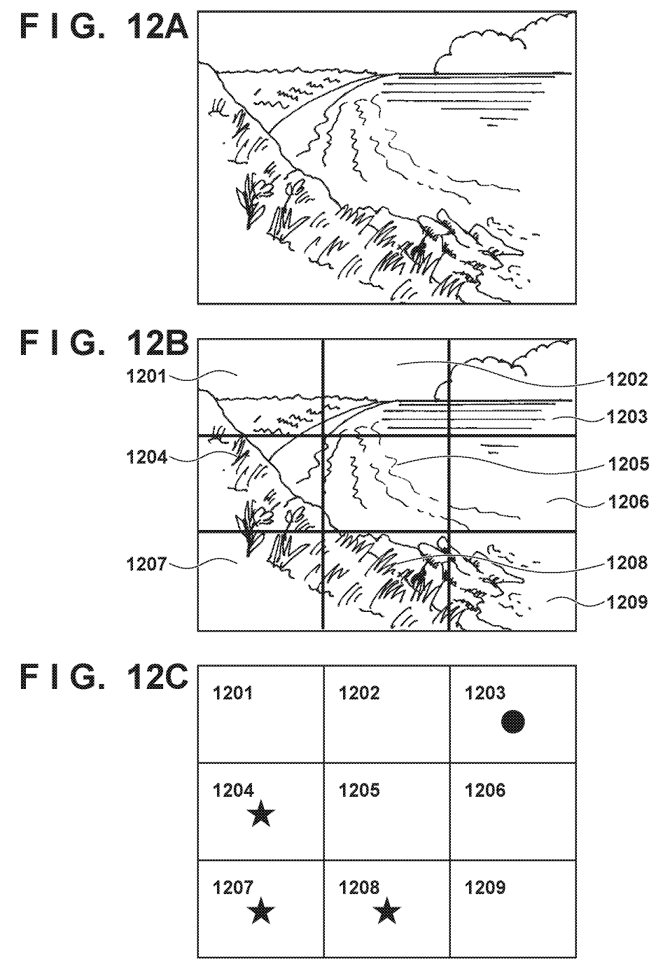

FIGS. 12A to 12C are conceptual diagrams illustrating an example of a method for analyzing whether edge detection is possible, and a method for selecting an image to be output based on the analysis results.

FIG. 12A is a conceptual diagram illustrating image luminance information received from the image information acquisition unit 210.

FIG. 12B illustrates divided images 1201 to 1209, each of which is obtained by dividing the image luminance information vertically by three and horizontally by three, into a total of nine regions. Note that the division method is not limited to this, and various modifications and variations are possible.

FIG. 12C shows an example of the results of the edge detection determination unit 1101 determining whether or not edges can be detected for the divided images 1201 to 1209. The black circle and black stars in FIG. 12C indicate areas where it is difficult to extract details using edge detection, while no mark indicates an area where edges can be detected. The black circle indicates an area where edges are difficult to detect due to low contrast, such as clouds. The black stars indicate areas where details of objects are difficult to discern due to complex depictions such as grass and leaves, resulting in parts other than the main edges being detected as edges.

In the case of FIG. 12B, it is determined that edge detection is difficult in the divided image 1203 due to low contrast caused by clouds, and in the divided images 1204, 1207, and 1208 due to the complicated depiction of grass.

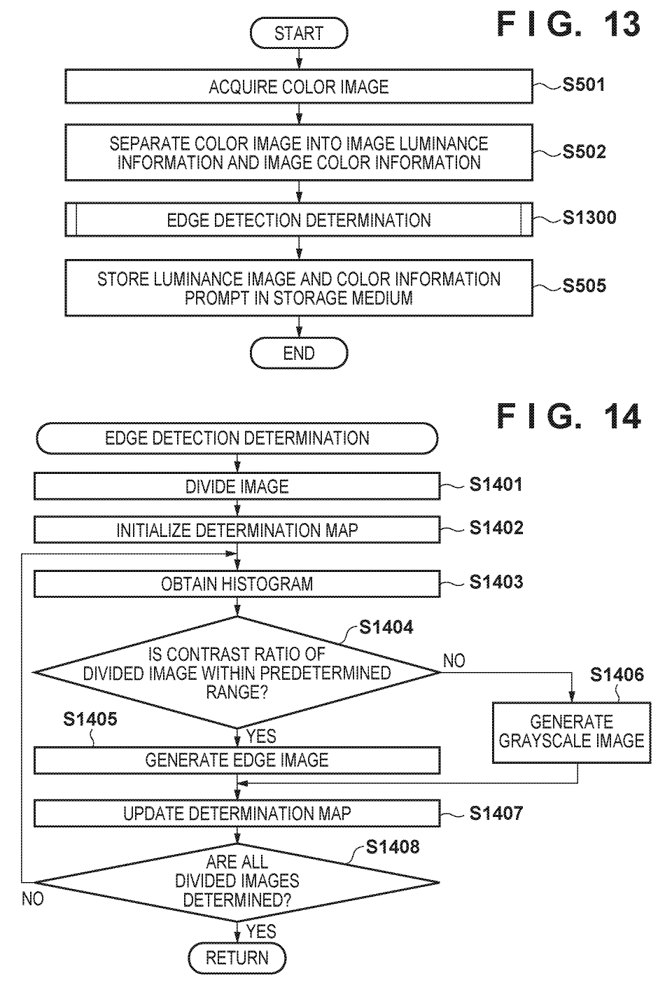

Next, an example of a series of processes performed in a case where the image capturing apparatus 101 captures an image and stores the grayscale image information 1102, edge image information 1103, and a color information prompt on a recording medium will be described with reference to the flowchart in FIG. 13. Note that the operation of each step is achieved by the CPU 202 executing a program recorded in the ROM 203 and controlling other hardware as necessary. In the processing shown in FIG. 13, the processes of steps S501, S502, and S505 are the same as those described in the first embodiment with reference to FIG. 5, and therefore the description thereof will be omitted.

In step S1300, the edge detection determination unit 1101 performs edge detection and analysis on the image luminance information, and outputs grayscale image information 1102, edge image information 1103, or both, depending on the analysis results. Then, the process proceeds to step S505.

FIG. 14 is a flowchart illustrating details of the edge detection determination process performed in step S1300. In this embodiment, an analysis method using a contrast ratio will be described as a method for determining whether an edge can be detected.

In step S1401, the edge detection determination unit 1101 divides the image luminance information, and the process proceeds to step S1402. Here, as an example, it is assumed that luminance information is divided into the divided images 1201 to 1209 as shown in FIG. 12B.

In step S1402, the edge detection determination unit 1101 initializes a determination map (not shown) for holding the analysis results of the divided images, and then the process proceeds to step S1403.

In step S1403, the edge detection determination unit 1101 obtains a histogram of the image luminance information of one divided image (e.g., divided image 1201), calculates the contrast ratio, and then the process proceeds to step S1404.

In step S1404, the edge detection determination unit 1101 determines whether the contrast ratio of the divided image is within a predetermined range. Here, the contrast ratio is compared with reference values, and based on the comparison, it is determined whether the edge image is appropriate for reproducing a color image. For example, in the case of an 8-bit luminance image per pixel, the reference value for a low contrast is generally set to between 3:1 and 1:1, and the reference value for a high contrast that interferes with edge detection is set to between 100:1 and 255:1. However, the reference values are not limited to these.

In a case where the contrast is low, edge detection is not possible and there is a high possibility that objects will disappear when the edge image is created. Therefore, an edge image is unsuitable for restoring a color image. On the other hand, in a case where the contrast is too high to cause problems with edge detection, there are many small objects and noise, and it is highly likely that an edge image will be generated in which even parts unnecessary for detail are captured as edges. Therefore, an edge image is also unsuitable for restoring a color image.

The determination method in step S1404 may be a method other than that described above. For example, the determination may be made based on whether or not there are a plurality of peaks in the histogram. If there are a plurality of peaks, it is likely that the image contains small objects or a lot of noise, so it can be determined that the edge image is unsuitable for restoring a color image.

If the comparison result indicates low contrast or high contrast that interferes with edge detection, as described above, the edge image is deemed unsuitable for reproducing details during restoration, and the process proceeds to step S1406. If the comparison result is anything other than this, the edge image is deemed suitable for reproducing details during restoration, and the process proceeds to step S1405.

In step S1405, the edge detection determination unit 1101 determines that the edge image is appropriate, so it generates edge image information 1103 and the process proceeds to step S1407.

On the other hand, in step S1406, the edge detection determination unit 1101 determines that the edge image is inappropriate, so it generates grayscale image information 1102 and the process proceeds to step S1407.

In step S1407, the edge detection determination unit 1101 stores the determination result of step S1404 for the divided image 1201 in the determination map. In the case of the divided image 1201, as shown in FIG. 12C, the selection of the edge image information 1103 is stored. Then, the process proceeds to step S1408.

In step S1408, the edge detection determination unit 1101 checks whether the determination and generation of output images for all divided images are completed. If not, the process returns to step S1403. If completed, the processing ends and the process proceeds to step S505 in FIG. 13.

In addition, when the grayscale image information 1102 or the edge image information 1103 is stored in the recording unit 208 in step S505, the determination map is stored together with the grayscale image information 1102 or the edge image information 1103. By using the determination map when restoring a color image using the image restoration apparatus 102, it is possible to generate a color image with high reproducibility.

As described above, according to the fourth embodiment, based on the results of determining whether edge detection is possible using the image luminance information, the edge image information 1103 is saved for areas where edge detection is possible, and this information is used to restore the color image. This makes it possible to reduce the amount of image data for the areas for which the edge image information 1103 is selected while maintaining the same level of reproducibility in details as in the first embodiment.

### FIFTH EMBODIMENT

Next, a fifth embodiment of the present disclosure will be explained.

In the fifth embodiment, an explanation is given of an example of a mechanism for maintaining details of an image while reducing an amount of data of images in which edge detection is difficult by converting the luminance image into a binary object image and using the color information prompt as an object information prompt.

In this embodiment, only the parts that are particularly different from those in the first embodiment will be described, and details of parts that are substantially the same as those in the first embodiment will be omitted as appropriate. As in the first embodiment, the image processing system in the fifth embodiment uses the image processing system 100 described with reference to FIGS. 1, 2 and 4.

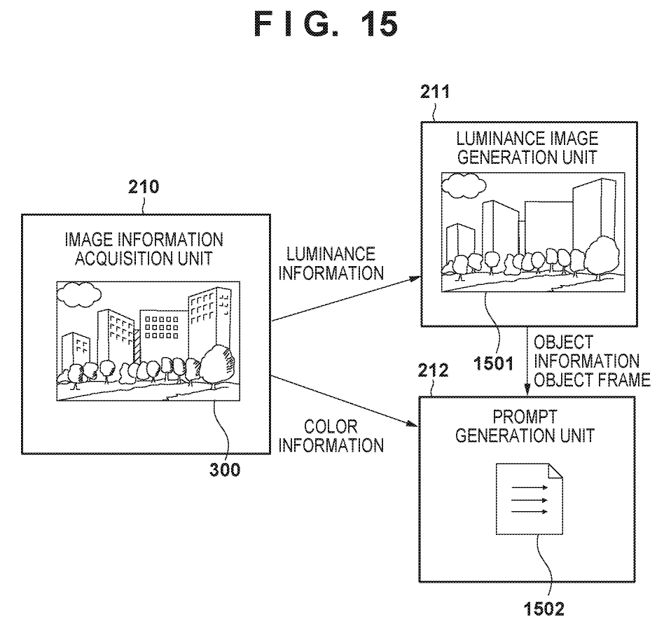

FIG. 15 is a conceptual diagram illustrating a mechanism for generating an object image and an object information prompt in the fifth embodiment.

The luminance image generation unit 211 generates a luminance image from the image luminance information received from the image information acquisition unit 210, detects objects included in the luminance image, and generates a binary object image 1501 that contains only the frame (outline) of the object.. The luminance image generation unit 211 also adds object information about each detected object to the object image 1501. The luminance image generation unit 211 detects the area and type of each object included in the luminance image, for example, by panoptic segmentation, and generates an object frame that emphasizes the outline of each object area, as well as object information such as the object type and location of the object. Note that a captured image may be used as the image to be subjected to the panoptic segmentation, instead of a luminance image.

The object information may be information that indicates the relationships between the objects, or any information related to the objects. The object information may be added by directly embedding the object information as character strings in the object image. Alternatively, information that associates the object frame with the object information may be generated, and the object information and the coordinates of the location of the object may be stored together as metadata for the image data of the object image. In other words, any storing method that associates the object frame with the object information may be used.

The prompt generation unit 212 analyzes the object frame, storing object information, and storing image color information together to generate an object information prompt 1502, which is text that indicates the color characteristics of each object. The prompt generation unit 212 analyzes the color code value within the target object, for example, from the pixel position and object frame included in the image color information. Then the object's base color information and object type is converted into an object information prompt. The color information may be of a plurality of colors, and a plurality of colors may be set for each region.

When the image restoration apparatus 102 restores the color image 401, it uses the object image 1501 and the object information prompt 1502 described above, making it possible to restore the color image 401 without losing the details of all objects that appeared in the color image 300 at the time of capture.

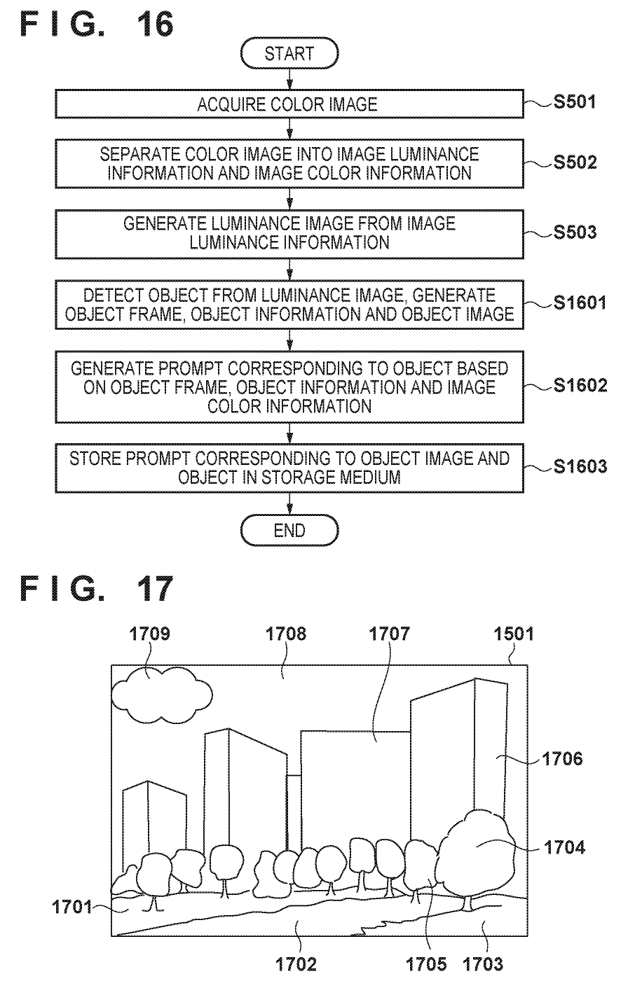

FIG. 16 is a flowchart of processing in the fifth embodiment. Here, an example of a series of processes will be described in which the image capturing apparatus 101 captures the image and stores the object image 1501 and the object information prompt 1502 on a recording medium. The operation of each step is realized by the CPU 202 executing a program recorded in the ROM 203 and controlling other hardware as necessary. In the processing shown in FIG. 16, steps S501 to S503 are the same as those described with reference to FIG. 5 in the first embodiment, and the explanation thereof is omitted.

In step S1601, the luminance image generation unit 211 detects each object from the luminance image, generates an object frame from the outline of the detected object area, and generates the object image 1501. It also generates object information from the object detection results and adds it to the object image 1501, and the process proceeds to step S1602.

In step S1602, the prompt generation unit 212 generates the object information prompt 1502, which is a prompt corresponding to each object, from the object frame, the object information, and the image color information, and the process proceeds to step S1603.

In step S1603, the recording unit 208 stores the object image 1501 and the object information prompt 1502. Note that, similar to the first embodiment, the recording unit 208 may store the object image 1501 and the object information prompt 1502 in association with each other. Then, the processing ends.

FIG. 17 is a diagram illustrating details of the object image 1501 in the fifth embodiment. For each object included in the object image 1501, an object name, created by combining the object's type (object information) and text for individual recognition, is embedded in the center of the frame. The object names are 1701: Lawn A, 1702: Road, 1703: Lawn B, 1704: Tree A, 1705: Tree B, 1706: Building A, 1707: Building B, 1708: Sky, and 1709: Cloud. Note that objects other than those described are separate entities of the same type, and therefore their description is omitted in this embodiment. The object name does not have to be embedded in the center of the frame; it can be embedded anywhere that allows the object frame and object name to correspond. The prompt generation unit 212 generates the object information prompt 1502 corresponding to each of the object names described above. Furthermore, information indicating the relationship between objects may be added, for example, in the case of the relationship between 1704: tree A and 1705: tree B, information indicating the relationship between the objects such as "1704: tree A is placed in front of 1705: tree B" may be added to the object information prompt 1502. By adding information indicating the relationship between objects, it is possible to maintain the details of the object image 1501, when it is restored, which has a reduced amount of information compared to the edge image 901 described in the third embodiment.

As described above, according to the fifth embodiment, by storing the object image 1501, which is an extracted version of only the outline of the object contained in the luminance image, and the object information prompt 1502, which is a prompt corresponding to each object, and using these to restore the color image, it is possible to reduce the amount of data for areas where edge image information is not selected, while maintaining the same level of reproducibility in details of each object, compared to the fourth embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004335, filed January 10, 2025, and Japanese Patent Application No. 2025-110914, filed June 30, 2025, which are hereby incorporated by reference herein in their entirety.

What is claimed is:

1. An image processing apparatus comprising one or more processors and/or circuitry which function as:
an acquisition unit that acquires an image;
a first generation unit that generates a luminance image indicating luminance of the acquired image; and
a second generation unit that generates text indicating characteristics of the acquired image.

2. The image processing apparatus according to claim 1, wherein the characteristics of the image include characteristics of color of the image.

3. The image processing apparatus according to claim 2, wherein the one or more processors and/or circuitry further functions as an image information acquisition unit that generates luminance information by converting the acquired image into luminance values and generates color information indicating color information of each pixel of the image,
wherein the first generation unit generates the luminance image based on the luminance information, and
the second generation unit generates the text based on the color information.

4. The image processing apparatus according to claim 3, wherein the second generation unit generates text that indicates the color information and position information of each pixel of the image.

5. The image processing apparatus according to claim 1, wherein the characteristics of the image include user setting information set by a user, image capture information when the image was captured, and color information of each subject included in the image.

6. The image processing apparatus according to claim 5, wherein the user setting information is information based on colors of the image set by the user.

7. The image processing apparatus according to claim 5, wherein the image capture information includes at least one of color temperature information, location information, time, and season when the image was captured, and manufacturer information of an image capturing apparatus that captured the image.

8. The image processing apparatus according to claim 3, wherein the first generation unit generates a luminance image that emphasizes contours extracted from the image based on the luminance values.

9. The image processing apparatus according to claim 3, wherein the first generation unit analyzes a contrast of the luminance values for each of a plurality of divided images obtained by dividing the acquired image, and generates either a luminance image in which contours extracted from the image are emphasized or a luminance image in which the contours are not emphasized, depending on the analyzed contrast.

10. The image processing apparatus according to claim 9, wherein the first generation unit generates a luminance image in which the contours are emphasized in a case where the contrast is within a predetermined range, and generates a luminance image in which the contours are not emphasized in a case where the contrast is not within the range.

11. The image processing apparatus according to claim 9, wherein the first generation unit further generates information indicating whether the luminance image with enhanced contours or the luminance image without enhanced contours is generated for each of the plurality of divided images.

12. The image processing apparatus according to claim 8, wherein the luminance image with enhanced contours is an image in which the luminance values of the image are expressed as binary values.

13. The image processing apparatus according to claim 1, wherein the one or more processors and/or circuitry further functions as a storage unit that stores the luminance image and the text.

14. The image processing apparatus according to claim 13, wherein the storage unit stores the text as additional information of the luminance image.

15. The image processing apparatus according to claim 1, wherein the one or more processors and/or circuitry further functions as a communication unit that transmits the luminance image and the text to an external device.

16. The image processing apparatus according to claim 3, wherein
the first generation unit detects an object included in the luminance image and generates an object image consisting of a frame of the object and object information related to the object, and
the second generation unit generates the text further based on the frame and the object information.

17. The image processing apparatus according to claim 16, wherein the first generation unit assigns the object information to each object constituting the object image.

18. The image processing apparatus according to claim 17, wherein the object information includes at least one of information that allows objects to be individually recognized and information that indicates the relationship between the objects.

19. The image processing apparatus according to claim 1, wherein the acquisition unit is an image capturing unit.

20. The image processing apparatus according to claim 1, wherein the acquisition unit acquires the image from an external device.

21. An image processing system comprising:
an image processing apparatus comprising one or more processors and/or circuitry which function as:
an acquisition unit that acquires an image;
a first generation unit that generates a luminance image indicating luminance of the acquired image; and
a second generation unit that generates text indicating characteristics of the acquired image; and
a restoration apparatus that generates an image using the luminance image and the text.

22. The image processing system according to claim 21 further comprising a display apparatus that displays the image generated by the restoration apparatus.

23. An image processing method comprising:
acquiring an image;
generating a luminance image indicating luminance of the acquired image; and
generating text indicating characteristics of the acquired image.

24. A non-transitory computer-readable storage medium, the storage medium storing a program that is executable by the computer, wherein the program includes program code for causing the computer to function as an image processing apparatus comprising:
an acquisition unit that acquires an image;
a first generation unit that generates a luminance image indicating luminance of the acquired image; and
a second generation unit that generates text indicating characteristics of the acquired image.
